(19) United States
(12) Patent Application Publication
(10) Pub. No.: US 2026/0332961 A1
(43) Pub. Date: Oct. 22, 2026

(54) ULTRA-SIMPLE BONE CONDUCTION SPEAKER, HEADSET AND GENERATOR

(71) Applicant: NINGBO SOGEN ELECTRONICS TECHNOLOGY CO., LTD., Yuyao (CN)

(72) Inventors: Hao ZHANG, Yuyao (CN); Tianshuo ZHANG, Yuyao (CN); Ronghua ZHU, Yuyao (CN); Diqiu CHEN, Yuyao (CN); Shundong PAN, Yuyao (CN); Wei ZHAO, Yuyao (CN); Yuqing LEI, Yuyao (CN)

(21) Appl. No.: 19/703,173

(22) Filed: Jun. 10, 2026

(30) Foreign Application Priority Data
Jun. 11, 2025 (CN) 202521196314.3
Jun. 27, 2025 (CN) 202521344395.7
Jul. 24, 2025 (CN) 202521566813.7
Jul. 29, 2025 (CN) 202521604355.1
Aug. 1, 2025 (CN) 202521639340.9
Aug. 21, 2025 (CN) 202521790826.2
Sep. 2, 2025 (CN) 202521885983.1
Sep. 12, 2025 (CN) 202521973300.8
Oct. 13, 2025 (CN) 202522158929.3
Oct. 13, 2025 (CN) 202522160078.6
Nov. 20, 2025 (CN) 202522463558.X

(51) Int. Cl. H04R 9/04; H04R 1/10; H04R 7/04; H04R 7/18; H04R 9/06

(52) U.S. Cl. CPC H04R 9/046; H04R 1/1008; H04R 1/1041; H04R 1/105; H04R 1/1066; H04R 1/1075; H04R 7/04; H04R 7/18; H04R 9/045; H04R 9/06; H04R 2201/107; H04R 2460/13

(57) ABSTRACT

The present invention discloses an ultra-simple bone conduction speaker, headset and generator. The ultra-simple bone conduction speaker includes a housing, an assembly cavity being formed in the housing; a vibrating plate, having a fixing portion fixed to the housing; a magnetic retention structure, located in the assembly cavity and fixed to a vibrating portion of the vibrating plate; and a voice coil structure, located in the assembly cavity, being ring-shaped and fixed to the housing, the magnetic retention structure being partially inserted into an inner circumference of the voice coil structure. The voice coil structure is mounted close to an inner wall of the assembly cavity to increase the thickness of the voice coil structure, such that a stronger magnetic field is generated to enhance the vibration intensity when the voice coil structure conducts an audio signal, and the structure is simplified to the maximum extent.

### BACKGROUND OF THE INVENTION

### 1. Technical Field

The present invention relates to the technical field of bone conduction speakers, in particular to an ultra-simple bone conduction speaker, headset and generator.

### 2. Description of Related Art

A bone conduction speaker vibrates by inputting a changing audio signal to a voice coil, which generates an electromagnetic force under the action of the magnetic field of a magnet. The vibrating speaker then directly acts on the skull bone (temporal bone), and the vibration is transmitted by the bone to the cochleae (inner ears), where it is finally perceived by the auditory nerve.

An existing bone conduction speaker includes a housing, a vibrating plate, a magnet, a yoke, a voice coil structure and a circuit board. An assembly cavity is formed in the housing. The vibrating plate is arranged at one end of the assembly cavity, the yoke is arranged on the vibrating plate and located inside the assembly cavity, the magnet is arranged inside the yoke, and the circuit board is arranged at the other end of the assembly cavity. The voice coil structure is arranged on the circuit board and located inside the assembly cavity. The voice coil structure is ring-shaped and inserted between the magnet and the voice coil structure, such that the voice coil structure, when conducting an audio signal, generates a magnetic field to act on the magnet, so as to drive the vibrating plate to vibrate.

The yoke is used to concentrate the magnetic field generated by the magnet to enhance the vibration intensity. However, the yoke occupies a large axial or radial space and involves a complex assembly process, hindering the development of the bone conduction speaker towards a thin, light and ultra-simple structure. Especially in a miniaturized design, the high machining and assembly accuracy requirements of the yoke become the main obstacle to further reduction in cost and size.

In order to omit the yoke, there has been a solution that attempts to create a magnetic retention structure merely consisting of a magnet and a pole piece, and the magnetic retention structure is matched with a voice coil and directly driven by the magnetic field of the magnet. However, without the magnetic conduction constraint of the yoke, the magnetic circuit becomes open, and a large number of magnetic lines of force diverge and leak outward. The actual magnetic induction intensity passing through an active conductor of the voice coil is greatly reduced, resulting in insufficient driving force and a significant reduction in the vibration intensity of the vibrating plate. As a result, the requirements for tactile vibration output of the bone conduction speakers cannot be satisfied. Therefore, how to still obtain a sufficient vibration intensity under an ultra-simple condition of completely removing the yoke and retaining only the voice coil and the magnetic retention structure has become a key issue to be settled in the art.

### BRIEF SUMMARY OF THE INVENTION

An objective of the present invention is to provide an ultra-simple bone conduction speaker, headset and generator. A voice coil structure is mounted close to an inner wall of an assembly cavity to increase the thickness of the voice coil structure, such that the effects of generating a stronger magnetic field to enhance the vibration intensity when the voice coil structure conducts an audio signal, and simplifying the structure to the maximum extent are achieved.

The above technical objective of the present invention is fulfilled by the following technical solution: An ultra-simple bone conduction speaker includes:
a housing, an assembly cavity being formed in the housing;
a vibrating plate, a fixing portion of the vibrating plate being fixed to the housing;
a magnetic retention structure, the magnetic retention structure being located in the assembly cavity, and the magnetic retention structure and a vibrating portion of the vibrating plate being fixed together; and
a voice coil structure, the voice coil structure being located in the assembly cavity, the voice coil structure being ring-shaped and fixed to the housing, and the magnetic retention structure being partially inserted into an inner circumference of the voice coil structure;
where a distance between an outer circumferential wall of the voice coil structure and an inner circumferential wall of the assembly cavity is d1, and a thickness of the voice coil structure is d2, where d1≤3 mm, or d1≤d2.

Further, a height of the magnetic retention structure is h1, and a depth of the magnetic retention structure inserted into the voice coil structure is h2, where h1/4≤h2≤(3*h1)/4.

Further, the assembly cavity is provided with a first opening, the voice coil structure is arranged at the first opening, and a first cover for sealing the first opening is arranged at an end, facing away from the vibrating plate, of the voice coil structure; and the first cover is made from a thermally conductive material.

Further, the assembly cavity is provided with a second opening, and the vibrating plate is assembled in the assembly cavity via the second opening; a second cover for sealing the second opening is fixedly arranged at the second opening; and a vibrating region is arranged between the second sealing cover and the vibrating plate to prevent the vibrating plate from colliding with the second cover during vibration.

Further, a vibrating diaphragm assembly is arranged on the vibrating plate, and the vibrating plate has a first conduction path and a second conduction path during a vibration process;
in the first conduction path, the vibrating plate transfers vibration energy to the housing and creates a bone conduction effect;
in the second conduction path, the vibrating plate transfers vibration energy to the vibrating diaphragm assembly and creates an air conduction effect;
where in the second conduction path, the vibrating diaphragm assembly transfers a portion of acting force generated by vibration to the housing and superposes the vibration energy to the first conduction path.

Further, the vibrating diaphragm assembly includes a vibrating bracket and a vibrating diaphragm connected to the vibrating bracket, the vibrating bracket and/or the vibrating diaphragm abuts against the housing, and the vibrating plate transfers the vibration energy to the vibrating diaphragm by means of the vibrating bracket and feeds the vibration energy back to the housing to form the second conduction path.

Further, the vibrating bracket includes an outer frame and a central platform, and the vibrating diaphragm is arranged on the central platform and abuts against the outer frame; and the outer frame and the central platform are spaced apart from each other and define an annular chamber, and the vibrating diaphragm and the vibrating plate form a top wall and a bottom wall of the annular chamber respectively.

Further, the voice coil structure includes a first voice coil and a second voice coil, the first voice coil and the second voice coil are arranged on the housing, a winding axis of the first voice coil and a winding axis of the second voice coil are collinear or parallel, a wire winding direction of the first voice coil and a wire winding direction of the second voice coil are opposite, a first magnetic end and a second magnetic end, which are different in magnetic polarity, are arranged at two ends of the magnetic retention structure, the first voice coil is arranged around the first magnetic end, and the second voice coil is arranged around the second magnetic end.

Further, the vibrating plate includes a first vibrating plate and a second vibrating plate, the first vibrating plate and the second vibrating plate are located at the two ends of the magnetic retention structure, and the first vibrating plate and the second vibrating plate are both fixedly connected to the magnetic retention structure; at least one end of the assembly cavity is provided with an opening, and the first voice coil, the second voice coil and the magnetic retention structure are located in the assembly cavity; and the first vibrating plate and the second vibrating plate are arranged at different openings of the assembly cavity, respectively.

Further, the vibrating plate includes a third vibrating plate, the third vibrating plate is located at one end of the magnetic retention structure and fixedly connected to the magnetic retention structure, and the other end of the magnetic retention structure is suspended; at least one end of the assembly cavity is provided with an opening; the first voice coil, the second voice coil and the magnetic retention structure are located in the assembly cavity; and the third vibrating plate is arranged at one opening of the assembly cavity.

Further, the vibrating plate further includes a first connecting portion and a second connecting portion which are movable relatively, the first connecting portion is arranged fixedly with respect to the housing, and the second connecting portion is provided with an assembly through-hole; and the magnetic retention structure extends through the assembly through-hole, and is arranged fixedly with respect to the second connecting portion, such that the magnetic retention structure is divided into a first magnetic retention portion and a second magnetic retention portion which are located on two sides of the second connecting portion, respectively.

Further, the voice coil structure includes a third voice coil and a fourth voice coil, and the third voice coil and the fourth voice coil are located on two sides of the first connecting portion; and the third voice coil is arranged around the first magnetic retention portion, and the fourth voice coil is arranged around the second magnetic retention portion;
a distance from an end, facing away from the first connecting portion, of the third voice coil to the first connecting portion is s1, and a distance from an end, facing away from the second connecting portion, of the first magnetic retention portion to the second connecting portion is s2, where s1>s2;
a distance from an end, facing away from the first connecting portion, of the fourth voice coil to the first connecting portion is s3, and a distance from an end, facing away from the second connecting portion, of the second magnetic retention portion to the second connecting portion is s4, where s3>s4.

Further, the ultra-simple bone conduction speaker further includes a strengthening member, where the strengthening member is arranged fixedly with respect to the housing and provided with a strengthening portion located on the inner circumference of the voice coil structure; and the magnetic retention structure and the strengthening portion are located on two sides of the vibrating portion of the vibrating plate.

Further, the voice coil structure includes:
a fifth voice coil, the fifth voice coil being tubular to form an inner chamber in the fifth voice coil, a third opening being formed in one end of the inner chamber, and a fourth opening being formed in the other an end of the inner chamber; and
a sixth voice coil, the sixth voice coil being arranged at the fourth opening, and the sixth voice coil being plate-like to cover at least a portion of the fourth opening.

Further, the vibrating plate is made from a soft magnetic material.

Further, the vibrating plate includes a central connecting portion connected to a vibrator drive source, as well as a fixing portion arranged outside the central connecting portion in a circumferential direction, and a vibration radiating portion is formed between the central connecting portion and the fixing portion; the vibration radiating portion includes at least two arc-shaped vibrating beams, inner ends of the arc-shaped vibrating beams are connected to the central connecting portion, outer ends of the arc-shaped vibrating beams are connected to the fixing portion, and the arc-shaped vibrating beams are distributed symmetrically around a central point of the central connecting portion and uniformly divide the central connecting portion and the fixing portion in a circumferential direction; and hollowed-out portions are formed in the vibrating plate, and a positional space where each hollowed-out portion is located is defined by the central connecting portion, the fixing portion and two adjacent arc-shaped vibrating beams jointly.

Further, the vibrating plate is of a circular or obround structure and includes a second vibrating portion and an annular fixing portion, the annular fixing portion is arranged around and spaced apart from the second vibrating portion, the second vibrating portion is connected to the annular fixing portion by means of a plurality of connecting arms, the number of the connecting arms is an even number, outer connecting ends of the connecting arms are fixedly connected to the annular fixing portion, and inner connecting ends of the connecting arms are fixedly connected to the second vibrating portion;
the outer connecting ends of at least two adjacent connecting arms are close to each other and connected to an inner circumferential wall of the annular fixing portion, and/or, the inner connecting ends of two adjacent connecting arm are close to each other and connected to an edge of the second vibrating portion.

The present invention further provides a bone conduction headset, including:
a first bone-conduction generation device, the first bone-conduction generation device including a first shell and a first circuit structure arranged on the first shell, and the first circuit structure including a first circuit board, a first power battery, a first control button and a first microphone unit which are electrically connected to the first circuit board, as well as the ultra-simple bone conduction speaker described above; and an ear hook, the ear hook being detachably connected to the first shell.

Further, a U-shaped clip slot is formed in an outer circumferential wall of the first shell, the ear hook includes a hooking portion and a clip bracket, the clip bracket is U-shaped, and the hooking portion is arranged at an end of the U-shaped clip bracket; the clip bracket is in snap fit with the clip slot to achieve assembly of the ear hook and the first shell;
a vibration output side to be attached to a face is arranged on a left side or a right side of the first shell; the clip slot includes a first slot section formed in a back side of the first shell, a second slot section formed in a lower side of the first shell and a third slot section formed in a front side of the first shell; the first slot section is open backward, the second slot section is open downward, and the third slot section is open forward; the clip bracket includes a first rod section matched with the first slot section, a second rod section matched with the second slot section, and a third rod section matched with the third slot section; the hooking portion is arranged on a back side of the clip bracket;
a clip notch is formed in a bottom of a back side of the third slot section, and the third rod section is bent to form a clip protrusion matched with the clip notch; and/or, a clip socket, which inclines forward and upward, is formed in a top of the third slot section, a rear lower portion of the clip socket communicates with the third slot section, and the third rod section is bent to form a clip insert to be inserted into the snap socket.

The present invention further provides a bone conduction generator, including the ultra-simple bone conduction speaker described above, and further including:
a second shell, a second assembly cavity being formed in the second shell, and the bone conduction speaker being arranged in the second assembly cavity;
a power battery, the power battery being arranged in the second assembly cavity;
a circuit board, the circuit board being arranged in the second assembly cavity, and the power battery and the bone conduction speaker being both electrically connected to the circuit board; and
a connector, the connector being detachably arranged on the second shell;
where the connector is used for detachably connecting a sound receiving body to the second shell, so as to configure the bone conduction generator on the sound receiving body.

To sum up, the present invention has the following beneficial effects:
1. For a small speaker with an inner diameter less than or equal to 15 mm, the setting of d1≤3 mm is adopted to maintain a small distance between the outer circumferential wall of the voice coil structure and the inner circumferential wall of the assembly cavity, such that the voice coil structure and the magnetic retention structure may be arranged as large as possible in the assembly cavity, for example, the thickness d2 of the voice coil structure in the horizontal direction may be increased to enable the voice coil structure to generate a stronger magnetic field to enhance the vibration intensity, and the size of the magnetic retention structure in the horizontal direction may be increased to enable the magnetic retention structure to generate a stronger magnetic field to enhance the vibration intensity.
2. For a large speaker with an inner diameter greater than 15 mm, the setting of d1≤d2 is adopted to maintain a small distance between the outer circumferential wall of the voice coil structure and the inner circumferential wall of the assembly cavity, such that the voice coil structure and the magnetic retention structure may be arranged as large as possible in the assembly cavity, for example, the thickness d2 of the voice coil structure in the horizontal direction may be increased to enable the voice coil structure to generate a stronger magnetic field to enhance the vibration intensity, and the size of the magnetic retention structure in the horizontal direction may be increased to enable the magnetic retention structure to generate a stronger magnetic field to enhance the vibration intensity.

The vibration intensity is enhanced in a specific region merely by using the voice coil structure with a larger size and the magnetic retention structure with a larger size, and the number of parts is decreased, thereby reducing the production cost and making the overall structure simpler.

### BRIEF DESCRIPTION OF THE SEVERAL VIEWS OF THE DRAWINGS

FIG. 1 is an assembly diagram of an ultra-simple bone conduction speaker according to Embodiment 1 of the present invention.

FIG. 2 is an exploded view of the ultra-simple bone conduction speaker according to Embodiment 1 of the present invention.

FIG. 3 is a sectional view of the ultra-simple bone conduction speaker according to Embodiment 1 of the present invention.

FIG. 4 is a partial enlarged view of FIG. 3 according to the present invention.

FIG. 5 is a sectional view of an ultra-simple bone conduction speaker according to Embodiment 2 of the present invention.

FIG. 6 is a stereogram of the ultra-simple bone conduction speaker according to Embodiment 2 of the present invention.

FIG. 7 is an assembly diagram of an ultra-simple bone conduction speaker according to Embodiment 3 of the present invention.

FIG. 8 is a sectional view of the ultra-simple bone conduction speaker according to Embodiment 3 of the present invention.

FIG. 9 is an exploded view of the ultra-simple bone conduction speaker according to Embodiment 3 of the present invention.

FIG. 10 is a sectional view of an ultra-simple bone conduction speaker according to Embodiment 4 of the present invention.

FIG. 11 is an exploded view of an ultra-simple bone conduction speaker according to Embodiment 5 of the present invention.

FIG. 12 is a sectional view of the ultra-simple bone conduction speaker according to Embodiment 5 of the present invention.

FIG. 13 is a schematic diagram of a vibrating plate according to Embodiment 5 of the present invention.

FIG. 14 is a sectional view of an ultra-simple bone conduction speaker according to Embodiment 6 of the present invention.

FIG. 15 is an exploded view of the ultra-simple bone conduction speaker according to Embodiment 6 of the present invention.

FIG. 16 is a sectional view of a fifth voice coil and a sixth voice coil according to Embodiment 7 of the present invention.

FIG. 17 is a schematic diagram of a vibrating plate according to Embodiment 8 of the present invention.

FIG. 18 is a schematic diagram of a vibrating plate according to Embodiment 9 of the present invention.

FIG. 19 is an assembly diagram of a bone conduction headset according to Embodiment 10 of the present invention.

FIG. 20 is a sectional view of the bone conduction headset according to Embodiment 10 of the present invention.

FIG. 21 is an exploded view of the bone conduction headset according to Embodiment 10 of the present invention.

FIG. 22 is an exploded view of a first bone-conduction generation device according to Embodiment 10 of the present invention.

FIG. 23 is a schematic diagram of a first shell according to Embodiment 10 of the present invention.

FIG. 24 is an assembly diagram of a bone conduction generator according to Embodiment 11 of the present invention.

FIG. 25 is a sectional view of the bone conduction generator in a case where a connector is removed according to Embodiment 111 1 of the present invention.

FIG. 26 is an exploded view of the bone conduction generator in a case where the connector is removed according to Embodiment 11 of the present invention.

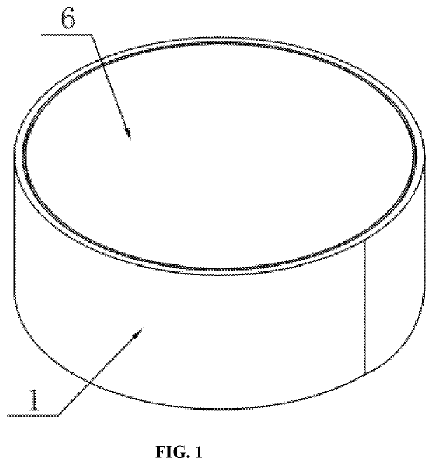

In the FIGS. 1, housing; 11, assembly cavity; 111, first opening; 112, second opening; 12, vibrating region; 13, strengthening member; 131, strengthening portion; 2, vibrating plate; 20, vibrating portion; 21, first vibrating plate; 22, second vibrating plate; 23, third vibrating plate; 24, first connecting portion; 25, second connecting portion; 251, assembly through-hole; 26, elastic deformation portion; 271, central connecting portion; 272, fixing portion; 273, arc-shaped vibrating beam; 274, inner end; 275, outer end; 276, hollowed-out portion; 277, second vibrating portion; 278, annular fixing portion; 279, connecting arm; 280, outer connecting end; 281, inner connecting end; 3, magnetic retention structure; 301, first magnetic end; 302, second magnetic end; 31, first magnetic retention portion; 32, second magnetic retention portion; 4, voice coil structure; 41, first voice coil; 42, second voice coil; 43, third voice coil; 44, fourth voice coil; 45, fifth voice coil; 451, inner chamber; 452, third opening; 453, fourth opening; 46, sixth voice coil; 5, first cover; 6, second cover; 71, vibrating bracket; 711, outer frame; 712, central platform; 72, vibrating diaphragm; 73, annular cavity; 8, first bone-conduction generation device; 80, ear hook; 801, hooking portion; 802, clip bracket; 81, first shell; 811, clip slot; 812, vibration output side; 82, first circuit structure; 821, first circuit board; 822, first power battery; 823, first control button; 824, first microphone unit; 83, first slot section; 84, second slot section; 85, third slot section; 851, clip notch; 852, clip socket; 86, first rod section; 87, second rod section; 88, third rod section; 881, clip protrusion; 882, clip insert; 91, second shell; 92, second assembly cavity; 93, power battery; 94, circuit board; 95, connector.

### DETAILED DESCRIPTION OF THE INVENTION

The present invention is further described below in conjunction with accompanying drawings.

### Embodiment 1

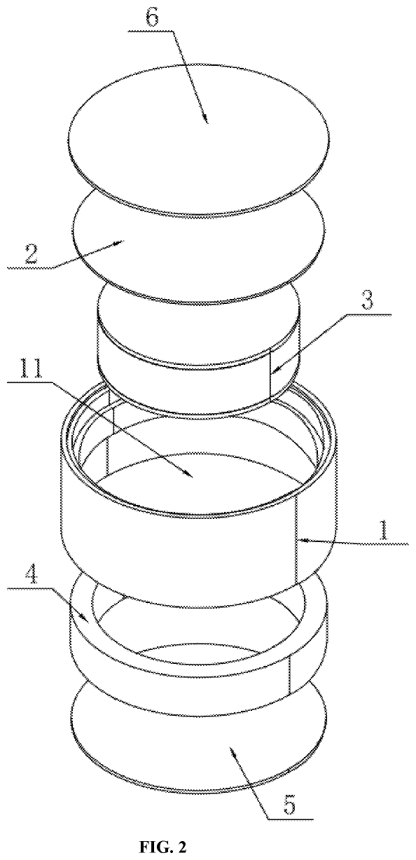

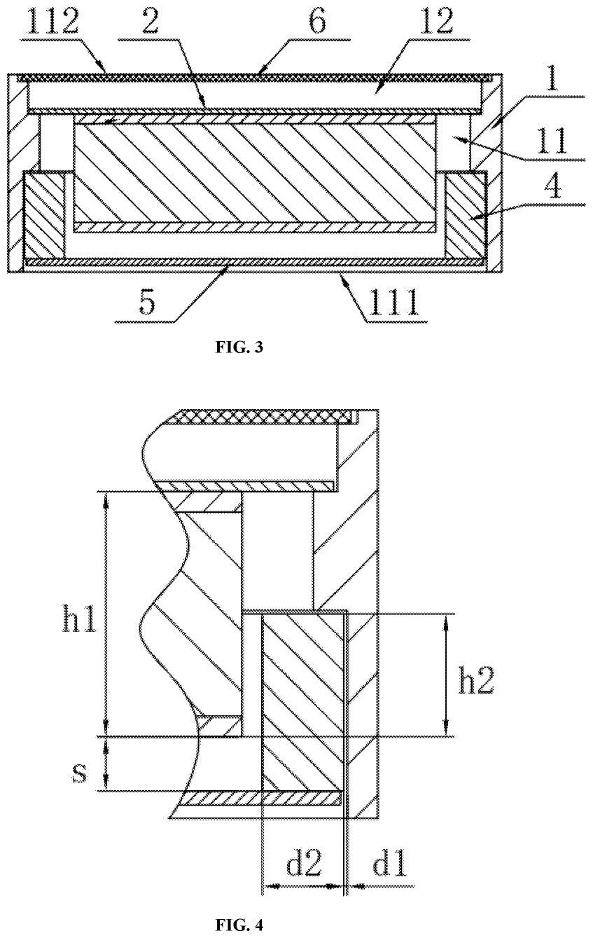

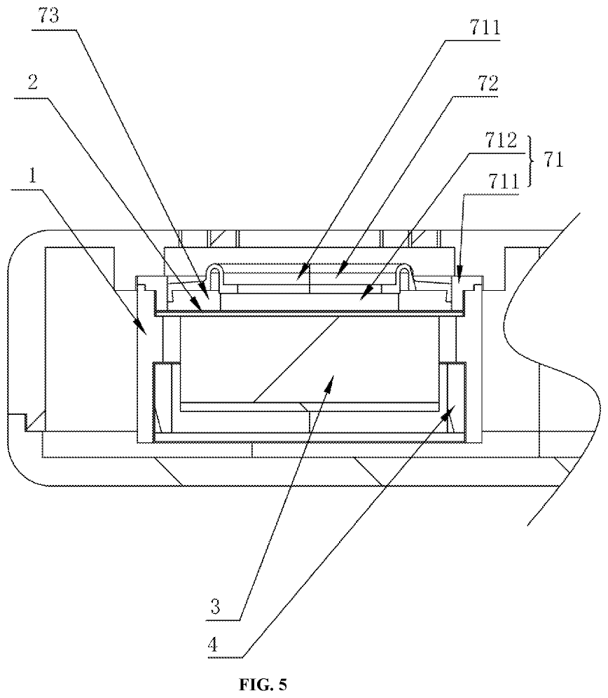

An ultra-simple bone conduction speaker, as shown in FIGS. 1-4, includes: a housing 1, an assembly cavity 11 being formed in the housing 1, a lower end of the assembly cavity 11 extending through the housing 1 and being provided with a first opening 111, and an upper end of the assembly cavity 11 extending through the housing 1 and being provided with a second opening 112;
a vibrating plate 2, the vibrating plate 2 being assembled in the assembly cavity 11 from the second opening 112, and bonded and fixed to the housing 1 by means of a fixing portion of the vibrating plate 2;
a magnetic retention structure 3, the magnetic retention structure 3 being fixed to a lower side of a vibrating portion of the vibrating plate 2 by adhesive bonding, and being assembled in the assembly cavity 11 together with the vibrating plate 2; and
a voice coil structure 4, the voice coil structure 4 being assembled in the assembly cavity 11 from the first opening 111 and being arranged fixedly with respect to the housing 1, where the voice coil structure 4 is ring-shaped, and a lower portion of the magnetic retention structure 3 is inserted into an inner circumference of the voice coil structure 4.

A distance between an outer circumferential wall of the voice coil structure 4 and an inner circumferential wall of the assembly cavity 11 is d1, and a thickness of the voice coil structure 4 is d2, where d1≤3 mm, or d1≤d2.

In this way, 1, for a small speaker with an inner diameter less than or equal to 15 mm, the setting of d1≤3 mm is adopted to maintain a small distance between the outer circumferential wall of the voice coil structure 4 and the inner circumferential wall of the assembly cavity 11, such that the voice coil structure 4 and the magnetic retention structure 3 may be arranged as large as possible in the assembly cavity 11, for example, a thickness d2 of the voice coil structure 4 in the horizontal direction may be increased to enable the voice coil structure 4 to generate a stronger magnetic field to enhance the vibration intensity, and the size of the magnetic retention structure 3 in the horizontal direction may be increased to enable the magnetic retention structure 3 to generate a stronger magnetic field to enhance the vibration intensity; 2, for a large speaker with an inner diameter greater than 15 mm, the setting of d1≤d2 is adopted to maintain a small distance between the outer circumferential wall of the voice coil structure 4 and the inner circumferential wall of the assembly cavity 11, such that the voice coil structure 4 and the magnetic retention structure 3 may be arranged as large as possible in the assembly cavity 11, for example, the thickness d2 of the voice coil structure 4 in the horizontal direction may be increased to enable the voice coil structure 4 to generate a stronger magnetic field to enhance the vibration intensity, and the size of the magnetic retention structure 3 in the horizontal direction may be increased to enable the magnetic retention structure 3 to generate a stronger magnetic field to enhance the vibration intensity; 3, the vibration intensity is enhanced in a specific region merely by using the voice coil structure 4 with a larger size and the magnetic retention structure 3 with a larger size, and the number of parts is decreased, thereby reducing the production cost and making the overall structure simpler.

Preferably, in this embodiment, 0 mm<d1<0.1 mm, such that only a minimal clearance is retained to ensure that the voice coil structure 4 may be smoothly assembled in the assembly cavity 11 from the first opening 111. In addition, an adhesive may be applied to the inner circumferential wall of the assembly cavity 11 and/or the outer circumferential wall of the voice coil structure 4 to effectively fill in a clearance d1 between the outer circumferential wall of the voice coil structure 4 and the inner circumferential wall of the assembly cavity 11, thereby guaranteeing the connection stability of the voice coil structure 4 and the housing 1 after the adhesive is cured.

Preferably, in this embodiment, a height of the magnetic retention structure 3 is h1, and a depth of the magnetic retention structure 3 inserted into the voice coil structure 4 is h2, where h1/4≤h2≤(3*h1)/4. In this way, the voice coil structure 4 and the magnetic retention structure 3 cooperate better with each other to produce stronger vibrations.

In addition, in this embodiment, a first cover 5 for sealing the first opening 111 is fixedly arranged at a lower end of the voice coil structure 4 by adhesive bonding.

The first cover 5 may be made from pure iron, copper, stainless steel, aluminum alloy, copper alloy, magnesium alloy, graphite, aluminum nitride, beryllia, or other thermally conductive materials, such that the first cover 5 may effectively absorb heat produced by the voice coil structure 4 in operation and dissipate the heat downward to prevent the voice coil structure 4 from being overheated and damaged.

In other embodiments, the first cover 5 may be a pcb, such that the voice coil structure 4 may be electrically connected to the pcb directly and then electrically connected to the outside by means of the pcb, thereby guaranteeing the convenience of assembly.

In addition, in this embodiment, a second cover 6 for sealing the second opening 112 is arranged at a position, corresponding to the second opening 112, of the housing 1.

In this way, the upper end and the lower end of the assembly cavity 11 are sealed by the second cover 6 and the first cover 5, respectively, thereby guaranteeing the operating stability of the vibrating plate 2, the magnetic retention structure 3 and the voice coil structure 4 in the assembly cavity 11.

Preferably, in this embodiment, the lower end of the voice coil structure 4 is lower than a lower end of the magnetic retention structure 3, and a height difference between the lower end of the magnetic retention structure 3 and the lower end of the voice coil structure 4 is s, where s>0 mm.

Due to the presence of the height difference s between the lower end of the voice coil structure 4 and the lower end of the magnetic retention structure 3, the magnetic retention structure 3 is prevented from downward colliding with the first cover 5 during the vibration process of the magnetic retention structure 3, thereby guaranteeing the stability of vibration.

Preferably, in this embodiment, a vibrating region 12 is arranged between the second cover 6 and the vibrating plate 2 to prevent the vibrating plate 2 from colliding with the second cover 6 during vibration.

Preferably, the vibrating plate 2 is made from a soft magnetic material.

### Embodiment 2

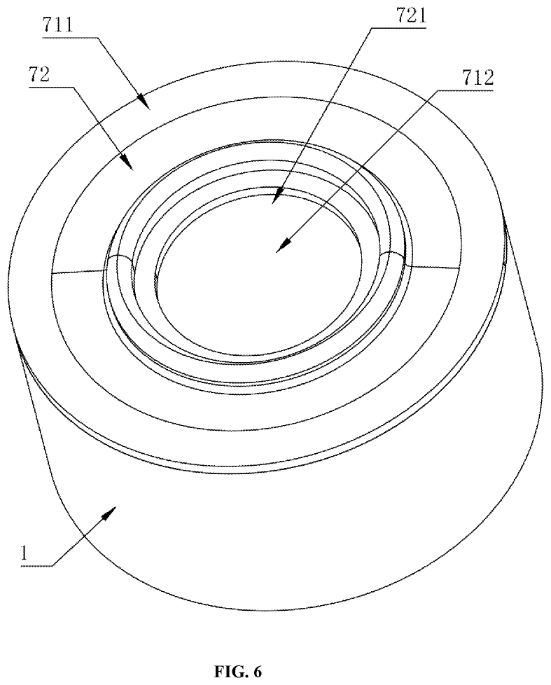

To improve the diversity and applicability of sound conduction, enhance the intensity and quality of the bone conduction effect, achieve the synergistic interaction between an air conduction mode and a bone conduction mode, and improve the clarity and overall performance of sound, this embodiment provides an ultra-simple bone conduction speaker. As shown in FIGS. 5-6, this embodiment is different from specific Embodiment 1 in that a vibrating diaphragm assembly is arranged on the vibrating plate 2, and the vibrating plate 2 has a first conduction path and a second conduction path during the vibration process.

In the first conduction path, the vibrating plate 2 transfers vibration energy to the housing 1 and creates a bone conduction effect. Specifically, the basic principle of the bone conduction effect is as follows: the vibrating plate 2 drives the housing 1 to vibrate, and the housing 1 abuts against the bone structure such as the skull bone or the jaw bone, which in turn directly transmits sound to the inner ears.

In the second conduction path, the vibrating plate 2 transfers vibration energy to the vibrating diaphragm assembly and creates an air conduction effect. Specifically, the basic principle of the air conduction effect is as follows: the vibrating plate 2 drives the vibrating diaphragm assembly to vibrate, and the vibrating diaphragm assembly vibrates to push air to vibrate to generate sound waves, which are conducted via air.

In the second conduction path, the vibrating diaphragm assembly transfers a portion of acting force generated by vibration to the housing 1 and superposes the vibration energy to the first conduction path. By adopting the above technical solution, two operating modes for the bone conduction effect and the air conduction effect are achieved, and vibration energy is transferred to both the housing 1 and the vibrating diaphragm assembly by means of the vibrating plate 2, such that users can perceive sound by bones and can also hear sound by air propagation, thereby improving the diversity and applicability of sound conduction. Particularly, a portion of the acting force in the second conduction path is fed back to the housing 1 and superposed onto the first conduction path, such that the intensity and quality of the bone conduction effect are enhanced, the synergistic interaction of the two conduction modes is achieved, and the clarity and overall performance of sound are improved.

Preferably, the vibrating diaphragm assembly includes a vibrating bracket 71 and a vibrating diaphragm 72 connected to the vibrating bracket 71. The vibrating diaphragm 72 is located on the vibrating bracket 71. The housing 1 is of a hollow cylindrical structure and has an inner wall abutting against an outer wall of the vibrating bracket 71. The vibrating plate 2 may only abut against the vibrating bracket 71, and the vibrating diaphragm 72 on the vibrating bracket 71 is driven to vibrate by vibration of the vibrating bracket 71. Alternatively, the vibrating plate 2 may abut against both the vibrating bracket 71 and the vibrating diaphragm 72, and the vibrating plate 2, when vibrating, directly drives the vibrating diaphragm 72 to vibrate and transfers the vibration to the vibrating diaphragm 72 by means of the vibrating bracket 71 to further drive the vibrating diaphragm 72 to vibrate, such that the vibration effect of the vibrating diaphragm 72 is improved. The vibrating plate 2 also transfers vibration energy to the vibrating bracket 71, and the vibrating bracket 71 then feeds the vibration energy back to the housing 1 to form the second conduction path. By adopting the above technical solution, the energy transfer path is simplified, the conduction efficiency is improved, and the energy loss is reduced.

Preferably, the vibrating bracket 71 includes an outer frame 711 and a central platform 712. The vibrating diaphragm 72 is arranged on the central platform 712 and abuts against the outer frame 711. The outer frame 711 is ring-shaped and has an outer wall abutting against an inner wall of the housing 1. The central platform 712 is located at the center of the outer frame 711 and is concentric with the outer frame 711. By means of such a structural design, the stability and flatness of the vibrating diaphragm 72 during the vibration process are guaranteed; and under the limitation of the outer frame 711, deformation or deflection of the vibrating diaphragm 72 is avoided, thus improving the accuracy and consistency of air-conducted sound, and enhancing structural durability.

Preferably, the outer frame 711 and the central platform 712 are spaced apart from each other and define a sealed annular cavity 73, and the vibrating diaphragm 72 and the vibrating plate 2 form a top wall and a bottom wall of the annular cavity 73, respectively. By means of the annular cavity 73, necessary vibration interference is reduced, acoustic resonance characteristics are optimized, and low-frequency responses and sound fullness are enhanced, and the quality and efficiency of air-conducted sound are improved.

### Embodiment 3

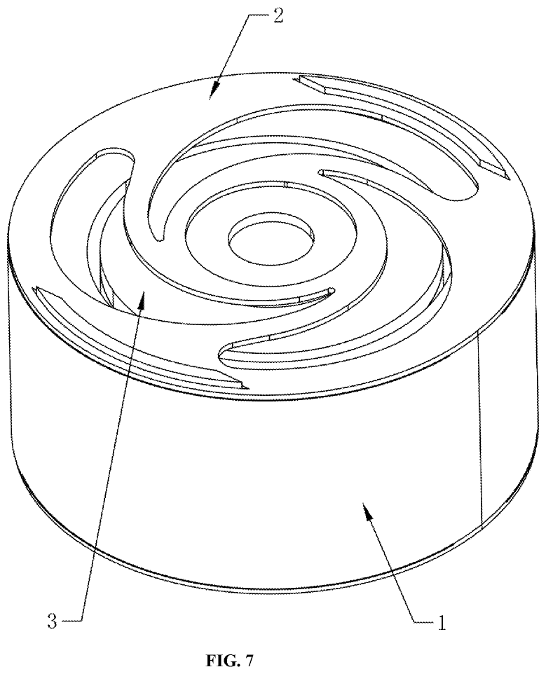

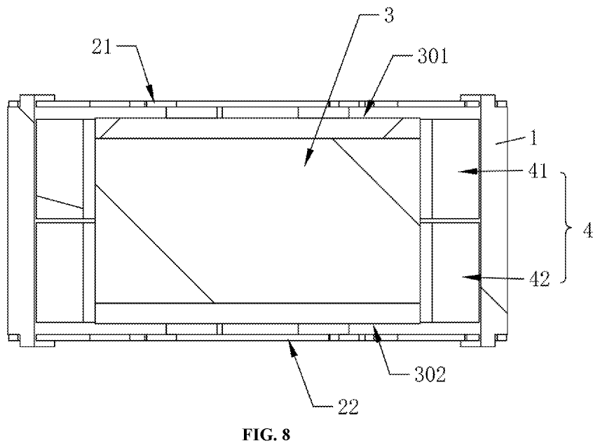

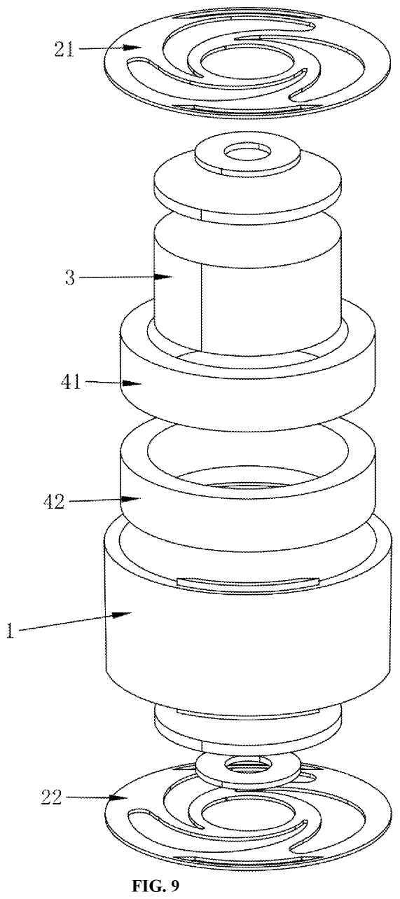

To further improve the vibration intensity, this embodiment provides an ultra-simple bone conduction speaker. As shown in FIGS. 7-9, this embodiment is different from specific Embodiment 1 in that the voice coil structure 4 includes a first voice coil 41 and a second voice coil 42, the first voice coil 41 and the second voice coil 42 are arranged on the inner circumferential wall of the assembly cavity 11 and fixed to the housing 1, for example, by adhesive bonding, and a winding axis of the first voice coil 41 and a winding axis of the second voice coil 42 are collinear. It should be noted that the winding axis of a voice coil is a central line of a columnar structure formed by spirally winding the voice coil. A wire winding direction of the first voice coil 41 is opposite to a wire winding direction of the second voice coil 42. It should be noted that the winding direction of the voice coil is a clockwise direction or an anticlockwise direction in which the coil is wound, viewed along the winding axis of the voice coil.

The magnetic retention structure 3 is located in the assembly cavity 11, and the magnetic retention structure 3 and the vibrating plate 2 are fixed together, such that the magnetic retention structure 3 and the vibrating plate 2 synchronously vibrate up and down. A first magnetic end 301 and a second magnetic end 302, which are different in magnetic polarity, are arranged at an upper end and a lower end of the magnetic retention structure 3. The first magnetic end 301 may be an N pole, and the second magnetic end 302 may be an S pole.

The first voice coil 41 is arranged around the first magnetic end 301, and the second voice coil 42 is arranged around the second magnetic end 302.

In this way, a same audio signal may be input to the first voice coil 41 and the second voice coil 42. Because the winding direction of the first voice coil 41 is opposite to the winding direction of the second voice coil 42, the current direction of the audio signal passing through the first voice coil 41 is opposite to the current direction of the audio signal passing through the second voice coil 42, that is, the current direction in one voice coil is clockwise while the current direction in the other voice coil is anticlockwise. Because the first voice coil 41 is arranged around the first magnetic end 301 and the second voice coil 42 is arranged around the second magnetic end 302, a vertical component of electromagnetic force generated by the first voice coil 41 and the magnetic retention structure 3 is the same as a vertical component of electromagnetic force generated by the second voice coil 42 and the magnetic retention structure 3, thereby improving the vibration intensity.

In other embodiments, the first voice coil 41 and the second voice coil 42 may horizontally deflect properly to make the winding axis of the first voice coil 41 parallel to the winding axis of the second voice coil 42.

Specifically, the vibrating plate 2 includes a first vibrating plate 21 and a second vibrating plate 22. The first vibrating plate 21 is fixedly arranged at an upper end of the housing 1 to cover a portion of the opening in the upper end of the assembly cavity 11, the second vibrating plate 22 is fixedly arranged at a lower end of the housing 1 to cover a portion of the opening in the lower end of the assembly cavity 11, and the first vibrating plate 21 is fixedly connected to an upper end of the magnetic retention structure 3 and the second vibrating plate 22 is fixedly connected to a lower end of the magnetic retention structure 3 by means of connecting blocks, respectively, such that the first vibrating plate 21, the second vibrating plate 22 and the magnetic retention structure 3 synchronously vibrate up and down.

### Embodiment 4

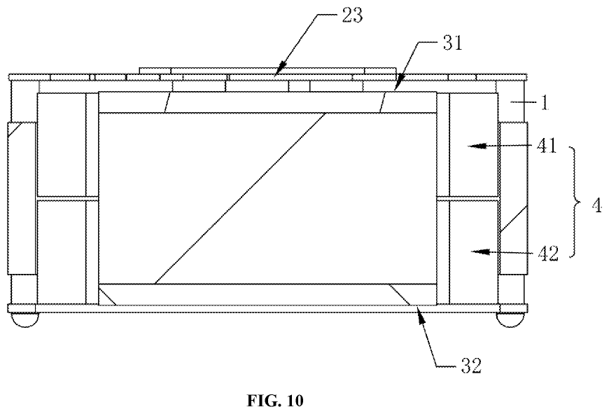

This embodiment provides an ultra-simple bone conduction speaker. As shown in FIG. 10, this embodiment is different from specific Embodiment 3 in that the vibrating plate 2 includes a third vibrating plate 23, the third vibrating plate 23 is fixedly arranged at an upper end of the housing 1 to cover a portion of the opening in the upper end of the assembly cavity 11, and the third vibrating plate 23 is fixedly connected to an upper end of the magnetic retention structure 3 by means of a connecting block, such that the third vibrating plate 23 and the magnetic retention structure 3 synchronously vibrate up and down.

The third vibrating plate 23 in this embodiment is identical in structure with the first vibrating plate 21 and the second vibrating plate 22 in Embodiment 3, and thus will not be detailed here.

In this embodiment, only the third vibrating plate 23 is connected to the upper side of the magnetic retention structure 3, such that during the vibration process, force is applied merely to the third vibrating plate 23, enabling an audio signal to be converted into a vibration signal more accurately. In Embodiment 3 where two vibrating plates are used, when the first vibrating plate 21 and the second vibrating plate 22 vibrate upward, the magnetic retention structure 3 pushes against the first vibrating plate 21 upwards, and the magnetic retention structure 3 pulls the second vibrating plate 22 upward, and due to the two different types of force, a vibration deviation occurs easily, resulting in inaccurate sound, which brings great difficulties in production and correction.

### Embodiment 5

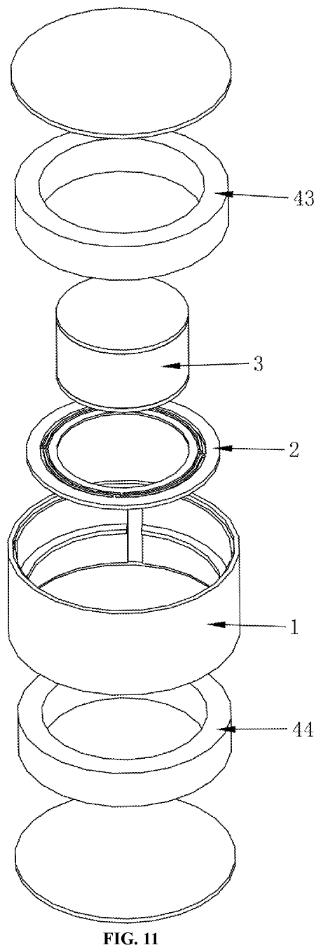

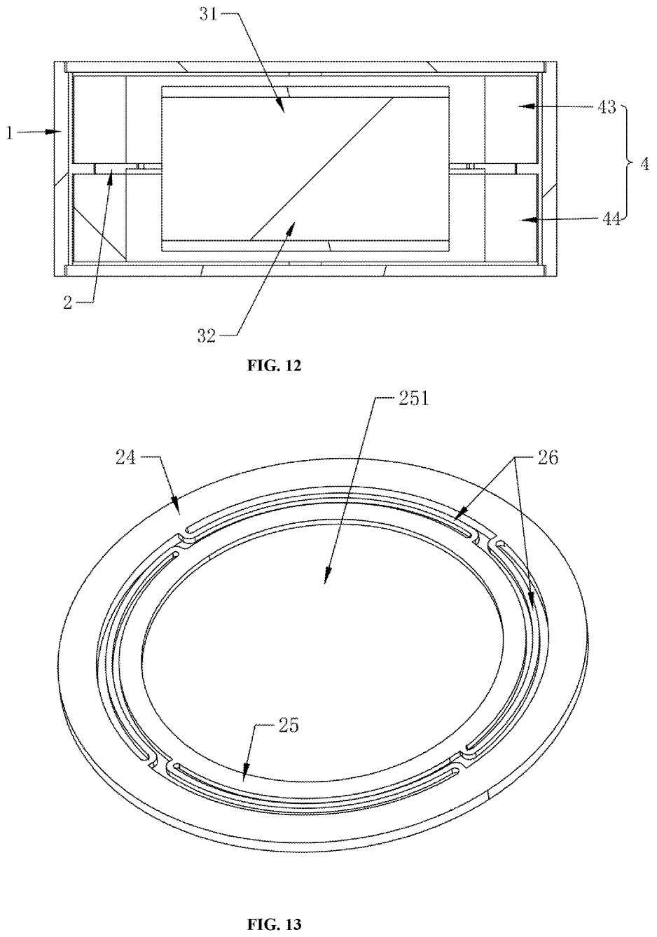

To achieve more stable installation of the magnetic retention structure 3, this embodiment provides an ultra-simple bone conduction speaker. As shown in FIGS. 11-13, this embodiment is different from specific Embodiment 1 in that the vibrating plate 2 is assembled in the assembly cavity 11 via an assembly opening. Specifically, the vibrating plate 2 includes a first connecting portion 24, a second connecting portion 25 and a plurality of elastic deformation portions 26. The first connecting portion 24 is ring-shaped and is arranged around the second connecting portion 25. Two ends of each of the plurality of elastic deformation portions 26 are integrally formed on and connected to an inner circumference of the first connecting portion 24 and an outer circumference of the second connecting portion 25, respectively, such that the first connecting portion 24 and the second connecting portion 25 are movable relatively by means of the deformable characteristics of the elastic deformation portions 26. The first connecting portion 24 is arranged fixedly with respect to the housing 1, and the second connecting portion 25 is ring-shaped, such that a circular assembly through-hole 251 is formed in the inner circumference of the second connecting portion 25. The magnetic retention structure 3 is assembled in the assembly cavity 11 via the assembly opening, the magnetic retention structure 3 extends through the assembly through-hole 251 and is fixedly arranged with respect to the second connecting portion 25 with an adhesive or the like, such that the magnetic retention structure 3 is divided into a first magnetic retention portion 31 and a second magnetic retention portion 32 located on two sides of the second connecting portion 25.

In this way, 1, an audio signal is input to the voice coil structure 4 to generate a varying magnetic field, the magnetic retention structure 3 generates a constant magnetic field, and under the action of the vibrating plate 2, the elastic deformation portions 26 deform to enable the voice coil structure 4 and the magnetic retention structure 3 to interact to move for vibration; 2, the second connecting portion 25 is provided with the assembly through-hole 251, and the magnetic retention structure 3 extends through the assembly through-hole 251 to be assembled and mounted on the second connecting portion 25, such that the magnetic retention structure 3 is unlikely to fall from the second connecting portion 25 in a drop test, thereby improving the assembly stability of the magnetic retention structure 3 to improve the drop resistance; 3, the voice coil structure 4, the vibrating plate 2 and the magnetic retention structure 3 are all arranged in the assembly cavity 11, such that the voice coil structure 4, the vibrating plate 2 and the magnetic retention structure 3 are protected by the housing 1 in the drop test, thereby further improving the assembly stability and drop performance of the overall structure.

In addition, compared with the prior art where the vibrating plate 2 is arranged at one end of the magnetic retention structure 3, in this embodiment, the vibrating plate 2 is arranged in the middle of the magnetic retention structure 3, such that the weight distribution of the magnetic retention structure 3 on two sides of the vibrating plate 2 is more uniform. In the drop test, if the magnetic retention structure 3 drops obliquely or horizontally, because the vibrating plate 2 is arranged at one end of the magnetic retention structure 3 in the prior art, the vibrating plate 2 will generate a large bending moment when the housing 1 impacts on the ground, leading to irreversible deformation of the elastic deformation portions 26 towards the magnetic retention structure 3, which in turn results in deflection of the magnetic retention structure 3. In this embodiment, the vibrating plate 2 is arranged in the middle of the magnetic retention structure 3, such that when the vibrating plate 2 drops, both the first magnetic retention portion 31 and the second magnetic retention portion 32 on the two sides of the vibrating plate 2 generate bending moments when the housing 1 impacts on the ground, and the bending moments are in opposite directions and thus are counteracted, such that the bending moment generated on the vibrating plate 2 is smaller to prevent or reduce irreversible deformation of the elastic deformation portions 26, thereby eliminating deflection of the magnetic retention structure 3.

Preferably, in this embodiment, the voice coil structure 4 includes a third voice coil 43 and a fourth voice coil 44, and the third voice coil 43 and the fourth voice coil 44 are located on two sides of the first connecting portion 24.

In this way, by vibration fit between the third voice coil 43 and the first magnetic retention portion 31 and vibration fit between the fourth voice coil 44 and the second magnetic retention portion 32, the vibration intensity of the speaker is improved.

Specifically, the two ends of the magnetic retention structure 3 are opposite in magnetic polarity; and the third voice coil 43 and the fourth voice coil 44 are both wound from wires, and a wire winding direction of the third voice coil 43 is opposite to a wire winding direction of the fourth voice coil 44.

In this way, by using the first magnetic retention portion 31 and the second magnetic retention portion 32 which are opposite in magnetic polarity to match the third voice coil 43 and the fourth voice coil 44 which are different in current direction, the acting force generated by the third voice coil 43 and the first magnetic retention portion 31 and the acting force generated by the fourth voice coil 44 and the second magnetic retention portion 32 are the same direction and thus can be superposed to enhance the vibration intensity.

In addition, the third voice coil 43 is arranged around the first magnetic retention portion 31, and the fourth voice coil 44 is arranged around the second magnetic retention portion 32. Preferably, a distance from an end, facing away from the first connecting portion 24, of the third voice coil 43 to the first connecting portion 24 is s1, a distance from an end, facing away from the second connecting portion 25, of the first magnetic retention portion 31 to the second connecting portion 25 is s2, and s1>s2. A distance from an end, facing away from the first connecting portion 24, of the fourth voice coil 44 to the first connecting portion 24 is s3, a distance from an end, facing away from the second connecting portion 25, of the second magnetic retention portion 32 to the second connecting portion 25 is s4, and s3>s4.

In this way, the end, facing away from the second connecting portion 25, of the first magnetic retention portion 31 is completely covered with the third voice coil 43 in the vibration direction, such that the height difference between the end of the third voice coil 43 and the end of the first magnetic retention portion 31 provides a safe vibration space for the first magnetic retention portion 31 to prevent interference when the first magnetic retention portion 31 vibrates, thereby preventing vibration output from being affected; and the end, facing away from the second connecting portion 25, of the second magnetic retention portion 32 is completely covered with the fourth voice coil 44, such that the height difference between the end of the fourth voice coil 44 and the end of the second magnetic retention portion 32 provides a safe vibration space for the second magnetic retention portion 32 to prevent interference when the second magnetic retention portion 32 vibrates, thereby preventing vibration output from being affected.

### Embodiment 6

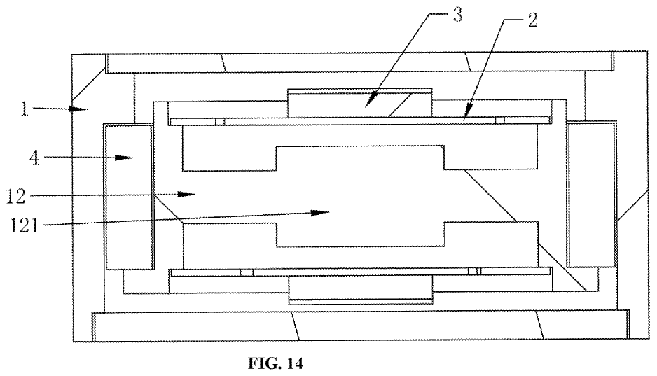

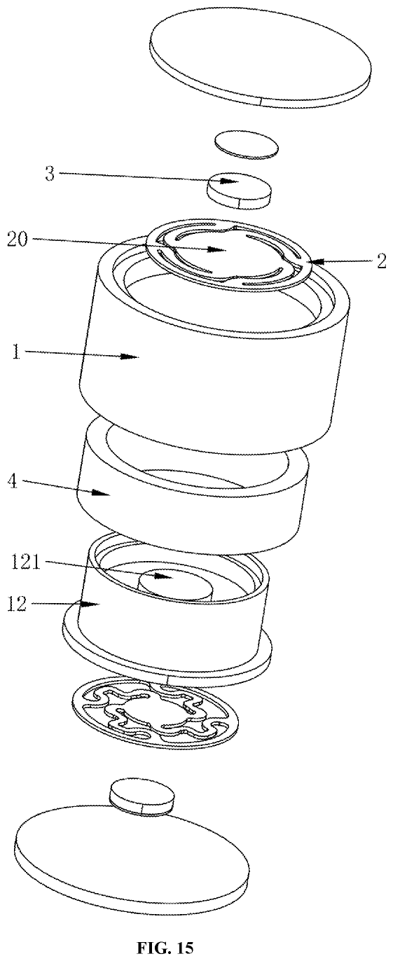

To improve the strength of action of the voice coil structure 4 and the magnetic retention structure 3 to thereby enhance the vibration intensity of the vibrating plate 2, this embodiment provides an ultra-simple bone conduction speaker. As shown in FIGS. 14-15, this embodiment is different from specific Embodiment 1 in that the ultra-simple bone conduction speaker further includes a strengthening member 13, and the strengthening member 13 is arranged fixedly with respect to the housing 1 and is provided with a cylindrical strengthening portion 131 located on the inner circumference of the voice coil structure 4; the magnetic retention structure 3 is arranged on the second vibrating portion 277 of the vibrating plate 2; and the magnetic retention structure 3 and the strengthening portion 131 are located on two sides of the second vibrating portion 277 of the vibrating plate 2.

In this way, 1, the strengthening portion 131 arranged on the inner circumference of the voice coil structure 4 can conduct the electromagnetic field generated by the voice coil structure 4 to make the electromagnetic field more concentrated, such that the strengthening portion 131 and the magnetic retention structure 3 work together to improve the interaction force so as to enhance the vibration intensity of the vibrating plate 2; 2, because the strengthening portion 131 is arranged on the inner circumference of the voice coil structure 4 and occupies the space of the side, facing the voice coil structure 4, of the vibrating plate 2, the magnetic retention structure 3 is arranged on a side, facing away from the strengthening portion 131, of the vibrating plate 2 to guarantee the effectiveness of vibration, such that the magnetic retention structure 3 will not interfere with the strengthening portion 131 during the vibration process.

### Embodiment 7

To enable the vibrating voice coil structure to generate a stronger magnetic field, this embodiment provides an ultra-simple bone conduction speaker. As shown in FIG. 16, this embodiment is different from specific Embodiment 1 in that the voice coil structure 4 includes:
a fifth voice coil 45, the fifth voice coil 45 is tubular to form an inner chamber 451 in the fifth voice coil 45, a third opening 452 being formed in an upper end of the inner chamber 451, and a fourth opening 453 being formed in a lower end of the inner chamber 451; and
a sixth voice coil 46, the sixth voice coil 46 being arranged at the fourth opening 453, and the sixth voice coil 46 being plate-like to cover at least a portion of the fourth opening 453.

In this way, 1, the inner chamber 451 is formed in the tubular fifth voice coil 45, and during installation, the space of the inner chamber 451 may be used for installation, such that space may be effectively filled in a case where the axial length is large enough, and when conducting an audio signal, the fifth voice coil 45 with a greater axial length may generate a stronger magnetic field for vibration, thereby enhancing the vibration intensity; 2, the plate-like sixth voice coil 46 has a small thickness and the increment of the sixth voice coil 46 along the axial length of the fifth voice coil 45 is small, while the sixth voice coil 46 has a large coverage in the horizontal direction, and when an audio signal is conducted, the sixth voice coil 46 with a larger coverage area in the horizontal direction may generate a greater magnetic field for vibration, thereby enhancing the vibration intensity; 3, the combination of the fifth voice coil 45 and the sixth voice coil 46 can make better use of the space to generate a stronger magnetic field for vibration.

### Embodiment 8

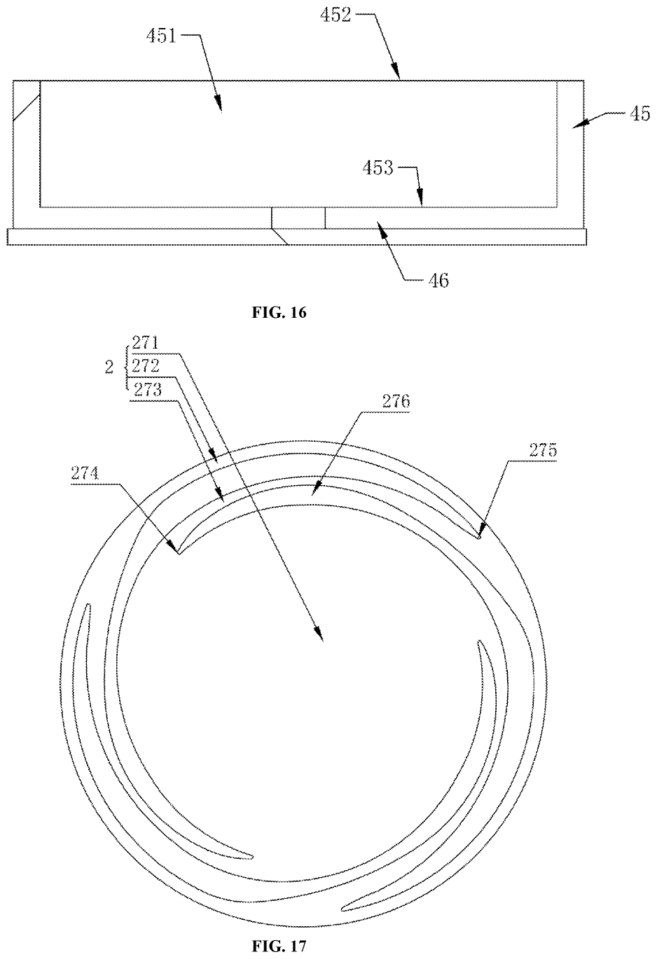

To improve vibration efficiency and uniformly radiate vibration energy of the vibrating plate 2 outward to optimize the sound quality, this embodiment provides an ultra-simple bone conduction speaker. As shown in FIG. 17, this embodiment is different from specific Embodiment 1 in that the vibrating plate 2 includes a central connecting portion 271 connected to a vibrator drive source, as well as a fixing portion 272 arranged outside the central connecting portion 271 in the circumferential direction, a vibration radiating portion is formed between the central connecting portion 271 and the fixing portion 272, and the central connecting portion 271, the fixing portion 272 and the vibration radiating portion are formed integrally; the vibration radiating portion includes at least two arc-shaped vibrating beams 273, inner ends 274 of the arc-shaped vibrating beams 273 are connected to the central connecting portion 271, outer ends 275 of the arc-shaped vibrating beams 273 are connected to the fixing portion 272, and the arc-shaped vibrating beams 273 are distributed symmetrically around a central point of the central connecting portion 271 and uniformly divide the central connecting portion 271 and the fixing portion 272 in the circumferential direction; and hollowed-out portions 276 are formed in the vibrating plate 2, and a positional space where each hollowed-out portion 276 is located is defined by the central connecting portion 271, the fixing portion 272 and two adjacent arc-shaped vibrating beams 273 jointly. The design of the hollowed-out portions 276 significantly reduces the overall rigidity of the vibrating plate 2, such that the arc-shaped vibrating beams 273 can deform more easily, thereby reducing energy required for driving; moreover, the vibrating plate 2 better fits the curved surface of human skin and bones, such that the wearing comfort and the vibration conduction effect are improved. Vibration energy is input from the vibrator drive source on the central connecting portion 271 and is transferred and radiated to human bones by means of the vibration radiating portion, and the fixing portion 272 is used for fixing the vibrating plate 2, for example, the vibrating plate 2 is fixed in a vibrator by applying an adhesive to the fixing portion 272.

### Embodiment 9

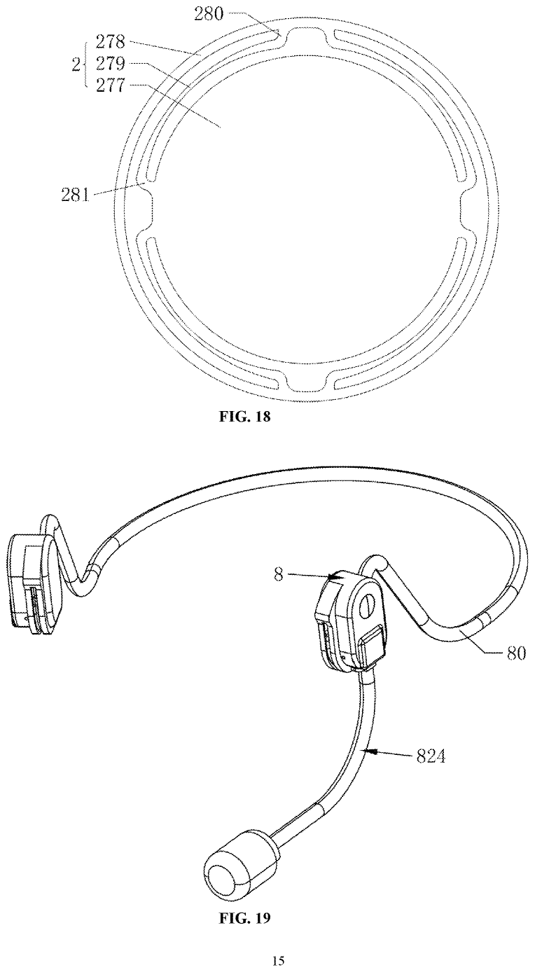

To improve vibration efficiency and uniformly radiate vibration energy of the vibrating plate 2 outward to optimize the sound quality, this embodiment provides an ultra-simple bone conduction speaker. As shown in FIG. 18, this embodiment is different from specific Embodiment 1 in that the vibrating plate 2 includes a second vibrating portion 277 and an annular fixing portion 278, and the annular fixing portion 278 is arranged around and spaced apart from the second vibrating portion 277; the second vibrating portion 277 is connected to the annular fixing portion 278 by means of a plurality of connecting arms 279, the number of the connecting arms 279 is an even number, and in this embodiment, the number of the connecting arms 279 is four; outer connecting ends 280 of the connecting arms 279 are fixedly connected to the annular fixing portion 278, and inner connecting ends 281 of the connecting arms 279 are fixedly connected to the second vibrating portion 277; and the outer connecting ends 280 of at least two adjacent connecting arms 279 are close to each other and connected to an inner circumferential wall of the annular fixing portion 278, and/or, the inner connecting ends 281 of two adjacent connecting arm 279 are close to each other and connected to an edge of the second vibrating portion 277.

The entire vibrating plate 2 is of a centrosymmetric and axisymmetric structure, the second vibrating portion 277, the annular fixing portion 278 and fourth connecting arms 279 are coplanar in the static state, and the vibrating plate 2 adopts a bisymmetric structure for forced vibration, such that energy is conducted vertically, the eccentric force is eliminated, and sound distortion is reduced; the plurality of connecting arms 279 disperse the stress uniformly to restrain sound radiation caused by non-axial vibration; the width of the connecting arms 279 increases gradually from the middle to the outer connecting ends 280 and the inner connecting ends 281 and is 0.1-0.8 mm, and by increasing the width of the regions close to the outer connecting ends 280 and the inner connecting ends 281 of the connecting arms 279, the contact areas between the outer connecting ends 280 and the inner connecting ends 281 and the corresponding annular fixing portion 278 and the second vibrating portion 277 can be enlarged, the rigid support capacity of the ends of the connecting arms 279 is improved, local stress is significantly reduced, and fatigue facture of materials caused by long-term vibration is avoided; the middle narrow regions can provide flexible elastic force to reduce energy dissipation for driving; in addition, in this embodiment, the thickness of the vibrating plate 2 is controlled to 0.1-0.3 mm, and the thinner vibrating plate 2 can provide quick response, thereby increasing the transient response starting speed of the vibrating plate 2.

### Embodiment 10

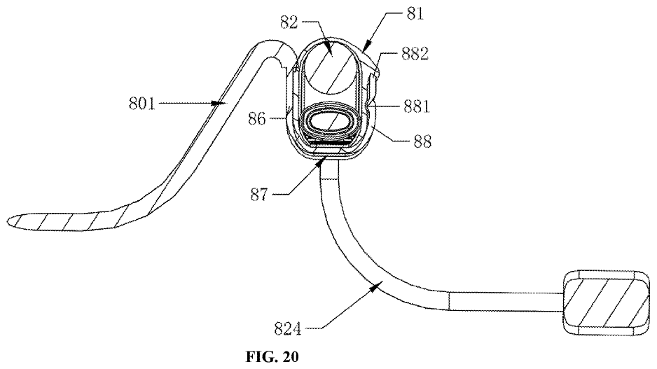

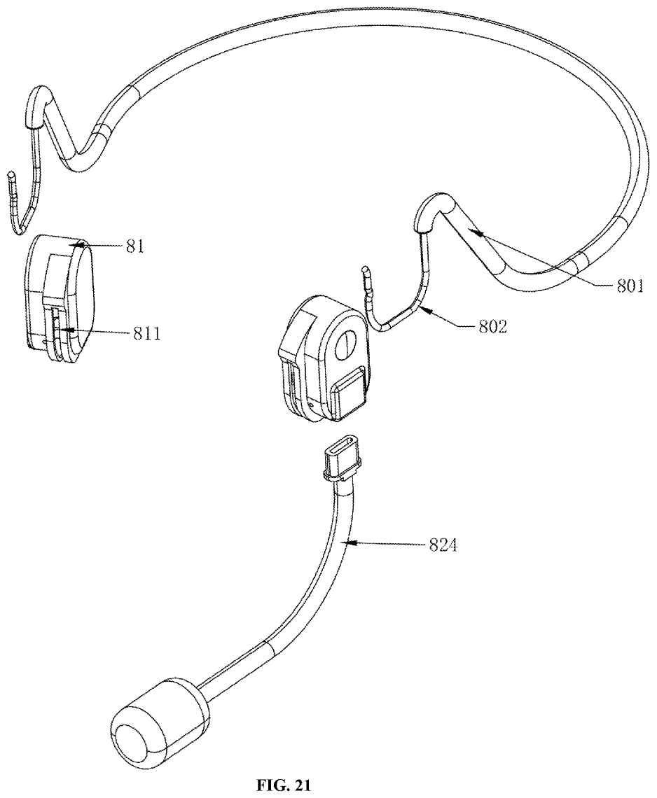

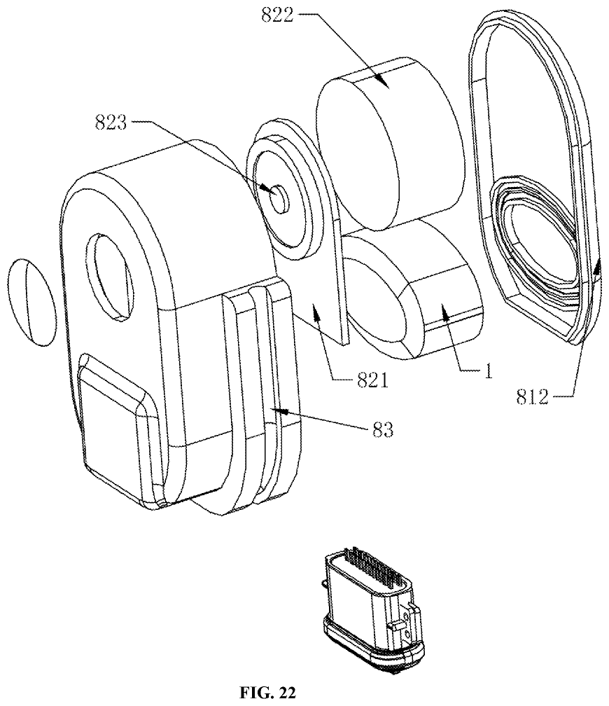

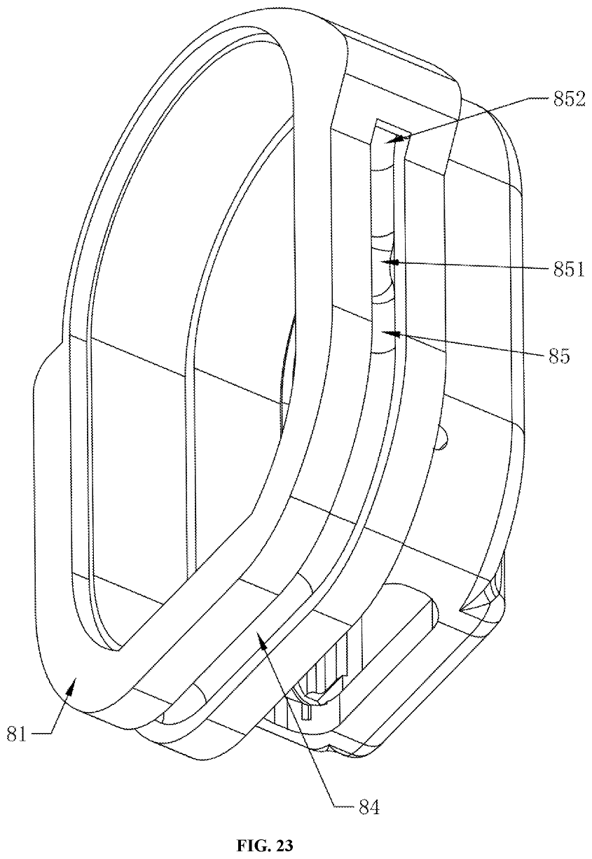

This embodiment provides a bone conduction headset, which as shown in FIGS. 19-23, includes:
a first bone-conduction generation device 8, the first bone-conduction generation device 8 including a first shell 81 and a first circuit structure 82 arranged on the first shell 81, and the first circuit structure 82 including a first circuit board 821, a first power battery 822, a first control button 823 and a first microphone unit 824 which are electrically connected to the first circuit board 821, as well as the ultra-simple bone conduction speaker described above; and
an ear hook 80, the ear hook 80 being detachably connected to the first shell 81.

In this way, 1, the first circuit structure 82 is assembled in the first shell 81 and is separated from the ear hook 80, such that the first circuit structure 82 will not be affected no matter whether the ear hook 80 is damaged or not; specifically, the first circuit board 821 functions as a control center to receive and send control commands, the first power battery 822 supplies power to the first circuit structure 82, a first bone conduction speaker unit operates to output vibrations for bone conduction, the first control button 823 may be operated by users to turn on or off the bone conduction headset and switch the operating modes, and the first microphone unit 824 is used for receiving sound; 2, the ear hook 80 is detachably mounted on the first shell 81, such that the ear hook 80 may be replaced when damaged, thereby improve the convenience of maintenance; moreover, when not used, the ear hook 80 and the first bone-conduction generation device 8 may be stored separately, thereby improving the safety of storage.

Preferably, in this embodiment, a U-shaped clip slot 811 is formed in an outer circumferential wall of the first shell 81, the ear hook 80 includes a hooking portion 801 and a clip bracket 802, the clip bracket 802 is U-shaped, and the hooking portion 801 is arranged at one end of the U-shaped clip bracket 802; and the clip bracket 802 is in snap fit with the clip slot 811 to achieve assembly of the ear hook 80 and the first shell 81.

Specifically, a vibration output side 812 to be attached to the face is arranged on a left side or a right side of the first shell 81; the clip slot 811 includes a first slot section 83 formed in a back side of the first shell 81, a second slot section 84 formed in a lower side of the first shell 81 and a third slot section 85 formed in a front side of the first shell 81; the first slot section 83 is open backward, the second slot section 84 is open downward, and the third slot section 85 is open forward; the clip bracket 802 includes a first rod section 86 matched with the first slot section 83, a second rod section 87 matched with the second slot section 84, and a third rod section 88 matched with the third slot section 85; and the hooking portion 801 is arranged on a back side of the clip bracket 802.

In this way, 1, the U-shaped clip slot 811 and the U-shaped clip bracket 802 are clamped and installed from front and back by snap-fit between the first slot section 83 and the first rod section 86 on the back side as well snap-fit between the third slot section 85 and the third rod section 88 on the front side, and are supported by snap-fit between the second slot section 84 and the second rod section 87 on the lower side, such that the assembly stability of the first shell 81 and the ear hook 80 is improved; 2, if the ear hook 80 and the first shell 81 need to be disassembled, the first shell 81 is pulled upward to be detached from the ear hook 80.

In addition, in this embodiment, a clip notch 851 is formed in the bottom of a back side of the third slot section 85, and the third rod section 88 is bent to form a clip protrusion 881 matched with the clip notch 851, such that the assembly stability of the first shell 81 and the ear hook 80 is further improved by snap-fit between the clip notch 851 and the clip protrusion 881, that is, a greater force is needed to detach the first shell 81 from the ear hook 80, making the first shell 81 unlikely to fall from the ear hook 80.

In addition, in this embodiment, a clip socket 852, which inclines forward and upward, is formed in the top of the third slot section 85, a rear lower portion of the clip socket 852 communicates with the third slot section 85, and the third rod section 88 is bent to form a clip insert 882 to be inserted into the snap socket 852, such that the assembly stability of the first shell 81 and the ear hook 80 is further improved by snap-fit between the clip socket 852 and the clip insert 882, that is, a greater force is needed to detach the first shell 81 from the ear hook 80, making the first shell 81 unlikely to fall from the ear hook 80.

### Embodiment 11

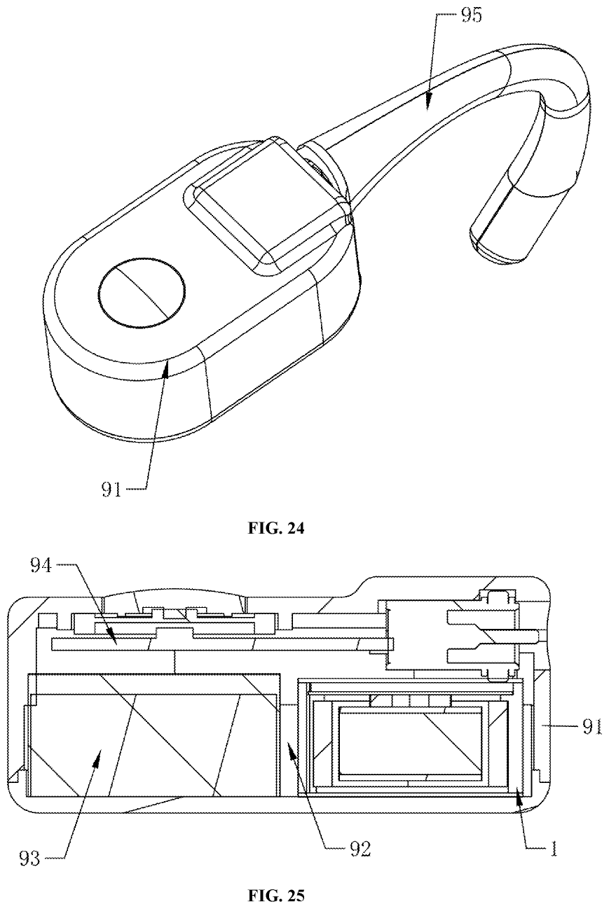

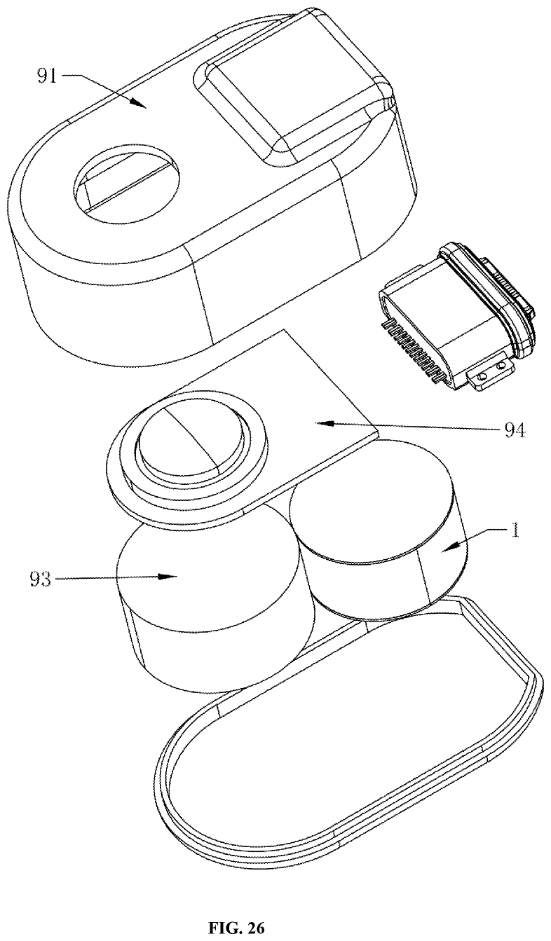

This embodiment provides a bone conduction generator, which as shown in FIGS. 24-26, includes the ultra-simple bone conduction speaker, and further includes:
a second shell 91, a second assembly cavity 92 being formed in the second shell 91, and the bone conduction speaker being fixed in the second assembly cavity 92 by adhesive bonding or snap fit;
a power battery 93, the power battery 93 being fixed in the second assembly cavity 92 by adhesive bonding or snap fit;
a circuit board 94, the circuit board 94 being fixed in the second assembly cavity 92 by adhesive bonding or snap fit, and the power battery 93 and the bone conduction speaker being both electrically connected to the circuit board 94; and
a connector 95, the connector 95 being detachably arranged on the second shell 91.

The connector 95 is used for detachably connecting a sound receiving body to the second shell 91, so as to configure the bone conduction generator on the sound receiving body.

In this embodiment, the connector 95 is an ear hook, and the sound receiving body is a human body.

In this way, 1, when the bone conduction generator is used, the ear hook and the second shell 91 are assembled, the bone conduction generator is hung on the ear by means of the ear hook, the second shell 91 abuts against the skull bone, and the speaker operates to drive the second shell 91 to vibrate to conduct vibration to the skull bone, and the skull bone directly transmits sound waves to the inner ear to complete bone conduction of the vibration; 2, when the bone conduction generator is not used, the ear hook and the second shell 91 are disassembled and separated from each other, such that when the bendable ear hook is damaged, the second shell 91 and structures in the second shell 91 will not be affected, and only the ear hook needs to be replaced; 3, the power battery 93, the bone conduction speaker and the circuit board 94 are arranged in the second shell 91, such that all circuit structures for bone conduction of vibration are assembled in the second shell 91, making the overall structure simple and compact.

The above embodiments are merely preferred ones of the present invention. All equivalent transformations or modifications made on the basis of the structures, features and principle within the patent application scope of the present invention should fall within the patent application scope of the present invention.

What is claimed is:

1. An ultra-simple bone conduction speaker, comprising:
a housing (1), an assembly cavity (11) being formed in the housing (1);
a vibrating plate (2), a fixing portion of the vibrating plate (2) being fixed to the housing (1);
a magnetic retention structure (3), the magnetic retention structure (3) being located in the assembly cavity (11), and the magnetic retention structure (3) and a vibrating portion of the vibrating plate (2) being fixed together; and
a voice coil structure (4), the voice coil structure (4) being located in the assembly cavity (11), the voice coil structure (4) being ring-shaped and fixed to the housing (1), and the magnetic retention structure (3) being partially inserted into an inner circumference of the voice coil structure (4);
wherein a distance between an outer circumferential wall of the voice coil structure (4) and an inner circumferential wall of the assembly cavity (11) is d1, and a thickness of the voice coil structure (4) is d2, wherein d1≤3 mm, or d1≤d2.

2. The ultra-simple bone conduction speaker according to claim 1, wherein a height of the magnetic retention structure (3) is h1, and a depth of the magnetic retention structure (3) inserted into the voice coil structure (4) is h2, wherein h1/4≤h2≤(3*h1)/4.

3. The ultra-simple bone conduction speaker according to claim 1, wherein the assembly cavity (11) is provided with a first opening (111), the voice coil structure (4) is arranged at the first opening (111), and a first cover (5) for sealing the first opening (111) is arranged at an end, facing away from the vibrating plate (2), of the voice coil structure (4); and the first cover (5) is made from a thermally conductive material.

4. The ultra-simple bone conduction speaker according to claim 1, wherein the assembly cavity (11) is provided with a second opening (112), and the vibrating plate (2) is assembled in the assembly cavity (11) via the second opening (112); a second cover (6) for sealing the second opening (112) is fixedly arranged at the second opening (112); and a vibrating region (12) is arranged between the second sealing cover (6) and the vibrating plate (2) to prevent the vibrating plate (2) from colliding with the second cover (6) during vibration.

5. The ultra-simple bone conduction speaker according to claim 1, wherein a vibrating diaphragm assembly is arranged on the vibrating plate (2), and the vibrating plate (2) has a first conduction path and a second conduction path during a vibration process;
in the first conduction path, the vibrating plate (2) transfers vibration energy to the housing (1) and creates a bone conduction effect;
in the second conduction path, the vibrating plate (2) transfers vibration energy to the vibrating diaphragm assembly and creates an air conduction effect;
wherein in the second conduction path, the vibrating diaphragm assembly transfers a portion of acting force generated by vibration to the housing (1) and superposes the vibration energy to the first conduction path.

6. The ultra-simple bone conduction speaker according to claim 5, wherein the vibrating diaphragm assembly comprises a vibrating bracket (71) and a vibrating diaphragm (72) connected to the vibrating bracket (71), the vibrating bracket (71) and/or the vibrating diaphragm (72) abuts against the housing (1), and the vibrating plate (2) transfers the vibration energy to the vibrating diaphragm (72) by means of the vibrating bracket (71) and feeds the vibration energy back to the housing (1) to form the second conduction path.

7. The ultra-simple bone conduction speaker according to claim 6, wherein the vibrating bracket (71) comprises an outer frame (711) and a central platform (712), and the vibrating diaphragm (72) is arranged on the central platform (712) and abuts against the outer frame (711); and the outer frame (711) and the central platform (712) are spaced apart from each other and define an annular chamber (73) and the vibrating diaphragm (72) and the vibrating plate (2) form a top wall and a bottom wall of the annular chamber (73) respectively.

8. The ultra-simple bone conduction speaker according to claim 1, wherein the voice coil structure (4) comprises a first voice coil (41) and a second voice coil (42), the first voice coil (41) and the second voice coil (42) are arranged on the housing (1), a winding axis of the first voice coil (41) and a winding axis of the second voice coil (42) are collinear or parallel, a wire winding direction of the first voice coil (41) and a wire winding direction of the second voice coil (42) are opposite, a first magnetic end (301) and a second magnetic end (302), which are different in magnetic polarity, are arranged at two ends of the magnetic retention structure (3), the first voice coil (41) is arranged around the first magnetic end (301), and the second voice coil (42) is arranged around the second magnetic end (302).

9. The ultra-simple bone conduction speaker according to claim 8, wherein the vibrating plate (2) comprises a first vibrating plate (21) and a second vibrating plate (22), the first vibrating plate (21) and the second vibrating plate (22) are located at the two ends of the magnetic retention structure (3), and the first vibrating plate (21) and the second vibrating plate (22) are both fixedly connected to the magnetic retention structure (3); at least one end of the assembly cavity (11) is provided with an opening, and the first voice coil (41), the second voice coil (42) and the magnetic retention structure (3) are located in the assembly cavity (11); and the first vibrating plate (21) and the second vibrating plate (22) are arranged at different openings of the assembly cavity (11), respectively.

10. The ultra-simple bone conduction speaker according to claim 8, wherein the vibrating plate (2) comprises a third vibrating plate (23), the third vibrating plate (23) is located at one end of the magnetic retention structure (3) and fixedly connected to the magnetic retention structure (3), and the other end of the magnetic retention structure (3) is suspended; at least one end of the assembly cavity (11) is provided with an opening; the first voice coil (41), the second voice coil (42) and the magnetic retention structure (3) are located in the assembly cavity (11); and the third vibrating plate (23) is arranged at one said opening of the assembly cavity (11).

11. The ultra-simple bone conduction speaker according to claim 1, wherein the vibrating plate (2) further comprises a first connecting portion (24) and a second connecting portion (25) which are movable relatively, the first connecting portion (24) is arranged fixedly with respect to the housing (1), and the second connecting portion (25) is provided with an assembly through-hole (251); and the magnetic retention structure (3) extends through the assembly through-hole (251), and is arranged fixedly with respect to the second connecting portion (25), such that the magnetic retention structure (3) is divided into a first magnetic retention portion (31) and a second magnetic retention portion (32) which are located on two sides of the second connecting portion (25), respectively.

12. The ultra-simple bone conduction speaker according to claim 11, wherein the voice coil structure (4) comprises a third voice coil (43) and a fourth voice coil (44), and the third voice coil (43) and the fourth voice coil (44) are located on two sides of the first connecting portion (24); and the third voice coil (43) is arranged around the first magnetic retention portion (31), and the fourth voice coil is arranged around the second magnetic retention portion (32);
a distance from an end, facing away from the first connecting portion (24), of the third voice coil (43) to the first connecting portion (24) is s1, and a distance from an end, facing away from the second connecting portion (25), of the first magnetic retention portion (31) to the second connecting portion (25) is s2, wherein s1>s2;
a distance from an end, facing away from the first connecting portion (24), of the fourth voice coil to the first connecting portion (24) is s3, and a distance from an end, facing away from the second connecting portion (25), of the second magnetic retention portion (32) to the second connecting portion (25) is s4, wherein s3>s4.

13. The ultra-simple bone conduction speaker according to claim 1, further comprising a strengthening member (13), wherein the strengthening member (13) is arranged fixedly with respect to the housing (1) and provided with a strengthening portion (131) located on the inner circumference of the voice coil structure (4); and the magnetic retention structure (3) and the strengthening portion (131) are located on two sides of the vibrating portion (20) of the vibrating plate (2).

14. The ultra-simple bone conduction speaker according to claim 1, wherein the voice coil structure (4) comprises:
a fifth voice coil (45), the fifth voice coil (45) being tubular to form an inner chamber (451) in the fifth voice coil (45), a third opening (452) being formed in one end of the inner chamber (451), and a fourth opening (453) being formed in the other an end of the inner chamber (451); and
a sixth voice coil (46), the sixth voice coil (46) being arranged at the fourth opening (453), and the sixth voice coil (46) being plate-like to cover at least a portion of the fourth opening (453).

15. The ultra-simple bone conduction speaker according to claim 1, wherein the vibrating plate (2) is made from a soft magnetic material.

16. The ultra-simple bone conduction speaker according to claim 1, wherein the vibrating plate (2) comprises a central connecting portion (271) connected to a vibrator drive source, as well as a fixing portion (272) arranged outside the central connecting portion (271) in a circumferential direction, and a vibration radiating portion is formed between the central connecting portion (271) and the fixing portion (272); the vibration radiating portion comprises at least two arc-shaped vibrating beams (273), inner ends (274) of the arc-shaped vibrating beams (273) are connected to the central connecting portion (271), outer ends (275) of the arc-shaped vibrating beams (273) are connected to the fixing portion (272), and the arc-shaped vibrating beams (273) are distributed symmetrically around a central point of the central connecting portion (271) and uniformly divide the central connecting portion (271) and the fixing portion (272) in a circumferential direction; and hollowed-out portions (276) are formed in the vibrating plate (2), and a positional space where each said hollowed-out portion (276) is located is defined by the central connecting portion (271), the fixing portion (272) and two said adjacent arc-shaped vibrating beams (273) jointly.

17. The ultra-simple bone conduction speaker according to claim 1, wherein the vibrating plate (2) is of a circular or obround structure and comprises a second vibrating portion (277) and an annular fixing portion (278), the annular fixing portion (278) is arranged around and spaced apart from the second vibrating portion (277), the second vibrating portion (277) is connected to the annular fixing portion (278) by means of a plurality of connecting arms (279), the number of the connecting arms (279) is an even number, outer connecting ends (280) of the connecting arms (279) are fixedly connected to the annular fixing portion (278), and inner connecting ends (281) of the connecting arms (279) are fixedly connected to the second vibrating portion (277);
the outer connecting ends (280) of at least two adjacent said connecting arms (279) are close to each other and connected to an inner circumferential wall of the annular fixing portion (278), and/or, the inner connecting ends (281) of two adjacent said connecting arm (279) are close to each other and connected to an edge of the second vibrating portion (277).

18. A bone conduction headset, comprising:
a first bone-conduction generation device (8), the first bone-conduction generation device (8) comprising a first shell (81) and a first circuit structure (82) arranged on the first shell (81), and the first circuit structure (82) comprising a first circuit board (821), a first power battery (822), a first control button (823) and a first microphone unit (824) which are electrically connected to the first circuit board (821), as well as the ultra-simple bone conduction speaker according to claim 1; and
an ear hook (80), the ear hook (80) being detachably connected to the first shell (81).

19. The bone conduction headset according to claim 18, wherein a U-shaped clip slot (811) is formed in an outer circumferential wall of the first shell (81), the ear hook (80) comprises a hooking portion (801) and a clip bracket (802), the clip bracket (802) is U-shaped, and the hooking portion (801) is arranged at an end of the U-shaped clip bracket (802); the clip bracket (802) is in snap fit with the clip slot (811) to achieve assembly of the ear hook (80) and the first shell (81);
a vibration output side (812) to be attached to a face is arranged on a left side or a right side of the first shell (81); the clip slot (811) comprises a first slot section (83) formed in a back side of the first shell (81), a second slot section (84) formed in a lower side of the first shell (81) and a third slot section (85) formed in a front side of the first shell (81); the first slot section (83) is open backward, the second slot section (84) is open downward, and the third slot section (85) is open forward; the clip bracket (802) comprises a first rod section (86) matched with the first slot section (83), a second rod section (87) matched with the second slot section (84), and a third rod section (88) matched with the third slot section (85); the hooking portion (801) is arranged on a back side of the clip bracket (802);
a clip notch (851) is formed in a bottom of a back side of the third slot section (85), and the third rod section (88) is bent to form a clip protrusion (881) matched with the clip notch (851); and/or, a clip socket (852), which inclines forward and upward, is formed in a top of the third slot section (85), a rear lower portion of the clip socket (852) communicates with the third slot section (85), and the third rod section (88) is bent to form a clip insert (882) to be inserted into the snap socket (852).

20. A bone conduction generator, comprising the ultra-simple bone conduction speaker according to claim 1, and further comprising:
a second shell (91), a second assembly cavity (92) being formed in the second shell (91), and the bone conduction speaker being arranged in the second assembly cavity (92);
a power battery (93), the power battery (93) being arranged in the second assembly cavity (92);
a circuit board (94), the circuit board (94) being arranged in the second assembly cavity (92), and the power battery (93) and the bone conduction speaker being both electrically connected to the circuit board (94); and
a connector (95), the connector (95) being detachably arranged on the second shell (91);
wherein the connector (95) is used for detachably connecting a sound receiving body to the second shell (91), so as to configure the bone conduction generator on the sound receiving body.
